(19) United States
(12) Patent Application Publication
(10) Pub. No.: US 2009/0147840 A1
(43) Pub. Date: Jun. 11, 2009

(54) VIDEO ENCODING SYSTEM WITH UNIVERSAL TRANSCODING AND METHOD FOR USE THEREWITH

(76) Inventors: Kuldip Sahdra, Richmond Hill (CA); Indra Laksono, Richmond Hill (CA); Lewis Leung, Markham (CA); Eric Young, Markham (CA); Edward Hong, North York (CA); Xu Gang Zhao, Toronto (CA); Paul Ducharme, Scarborough (CA)

Correspondence Address: GARLICK HARRISON & MARKISON, P.O. BOX 160727, AUSTIN, TX, 78716-0727, US

(21) Appl. No.: 11/950,491

(22) Filed: Dec. 5, 2007

(51) Int. Cl. H04N 11/02

(52) U.S. Cl. 375/240.01; 375/E07.076

(57) ABSTRACT

An encoding system includes a first signal interface for receiving a first video signal in a first format. A second signal interface receives a second video signal in a second format. A first encoding module generates a first processed video signal in a third format. A second encoding module generates a second processed video signal in a fourth format, wherein the second processed signal is generated contemporaneously with the first processed video signal and wherein the first format differs from the third format and the second format differs from the fourth format.

### CROSS REFERENCE TO RELATED PATENTS

The present application is related to the co-pending application, VIDEO PROCESSING DEVICE, VIDEO RECORDER/PLAYBACK MODULE, AND METHODS FOR USE THEREWITH, having Ser. No. 11/504,320, and filing date Aug. 15, 2006, the contents of which is incorporated herein by reference thereto.

### TECHNICAL FIELD OF THE INVENTION

The present invention relates to encoding of media signals such as video signals.

### DESCRIPTION OF RELATED ART

With the number of households having multiple television sets increasing, and many users wanting the latest and greatest video viewing services. As such, many households have multiple satellite receivers, cable set-top boxes, modems, et cetera. For in-home Internet access, each computer or Internet device has its own Internet connection. As such, each computer or Internet device includes a modem.

As an alternative, an in-home wireless local area network may be used to provide Internet access and to communicate multimedia information to multiple devices within the home. In such an in-home local area network, each computer or Internet device includes a network card to access a server. The server provides the coupling to the Internet. The in-home wireless local area network (WLAN) can also be used to facilitate an in-home computer network that couples a plurality of computers with one or more printers, facsimile machines, as well as to multimedia content from a digital video recorder, set-top box, broadband video system, etc.

Digital video recorders, that digitize and store broadcast video signals, have gained popularity over the last several years. Users can select programs of interest and have easy access to the programs that they have recorded for playback at any time. The buffering that is used also allows live television broadcasts to be paused, rewound and played in slow motion, etc. Originally manufactured as stand alone devices, software applications, such as Microsoft Media Center Edition 2005 allow users to operate their computer as a digital video recorder.

In addition, handheld multifunction devices are being manufactured with video display functionality. Examples include the Apple iPod, Palm Treo, etc. While these devices are capable of playing digital video files, they cannot receive broadcast video signals and do not contain the functions and features of a digital video recorder. A single user may wish to watch a video program that came from any of a number of sources on any of a number of different devices.

The limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIG. 1 presents a block diagram representation of a video processing system 150 in accordance with an embodiment of the present invention.

FIG. 2 presents a pictorial representation of example host devices 11-16 in accordance with an embodiment of the present invention.

FIG. 3 presents a block diagram representation of a video encoding system 102 in accordance with an embodiment of the present invention.

FIG. 4 presents a block diagram representation that represents the processing flow of video encoding system 102 in accordance with an embodiment of the present invention.

FIG. 5 presents a block diagram representation of a video distribution system 175 in accordance with an embodiment of the present invention.

FIG. 6 presents a block diagram representation of a video storage system 179 in accordance with an embodiment of the present invention.

FIG. 7 presents a block diagram representation of a video record/playback device 13 in accordance with an embodiment of the present invention.

FIG. 8 presents a pictorial representation of a video device setup menu 300 in accordance with an embodiment of the present invention.

FIG. 9 presents a pictorial representation of a recording defaults menu 310 in accordance with an embodiment of the present invention.

FIG. 10 presents a pictorial representation of a recording options menu 320 in accordance with an embodiment of the present invention.

FIG. 11 presents a flowchart representation of a method in accordance with an embodiment of the present invention.

FIG. 12 presents a flowchart representation of a method in accordance with an embodiment of the present invention.

### DETAILED DESCRIPTION OF THE INVENTION INCLUDING THE PRESENTLY PREFERRED EMBODIMENTS

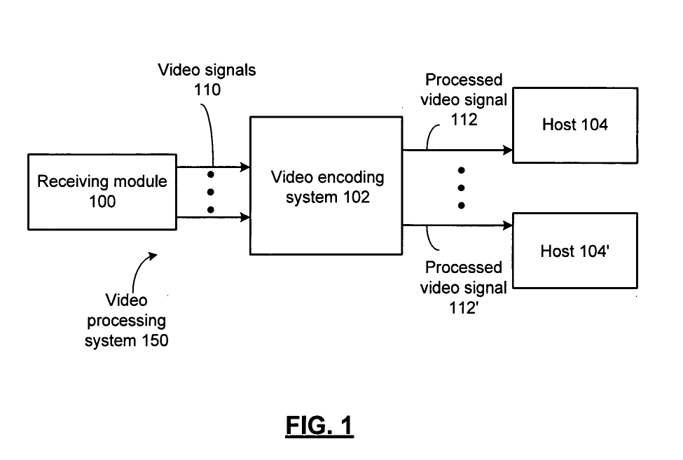

FIG. 1 presents a block diagram representation of a video processing system 150 in accordance with an embodiment of the present invention. In particular, video processing system 150 includes a receiving module 100, such as a set-top box, television receiver, personal computer, cable television receiver, satellite broadcast receiver, broadband modem, 3G transceiver or other information receiver or transceiver that is capable of receiving video signals 110 from one or more sources such as a broadcast cable system, IP television network, a broadcast satellite system, the Internet, a digital video disc player, a digital video recorder, or other video source.

Video encoding system 102 is coupled to the receiving module 100 to universally transcode, one or more of the video signals 110 to form a plurality of processed video signals 112, 112′, etc. that are transferred to respective hosts 104 that play, process, store, distribute or otherwise operate based on the processed video signals 112, 112′, etc. This universal transcoding can include transcoding, including transrating and transcaling, and in addition, encrypting or transcrypting, each of the video signals 110 into one or more processed video signals 112, 112′, etc. in differing formats.

In an embodiment of the present invention, the video signals 110 can include a broadcast video signal, such as a television signal, high definition television signal, enhanced high definition television signal or other broadcast video signal that has been transmitted over a wireless medium, either directly or through one or more satellites or other relay stations or through a cable network, optical network or other transmission network. In addition, the video signals 110 can be generated from a stored video file, played back from a recording medium such as a magnetic tape, magnetic disk or optical disk, and can include a streaming video signal that is transmitted over a public or private network such as a local area network, wide area network, metropolitan area network or the Internet.

Video signals 110 can include analog video signals that are formatted in any of a number of video formats including National Television Systems Committee (NTSC), Phase Alternating Line (PAL) or Sequentiel Couleur Avec Memoire (SECAM). Processed video signals 112, 112′ can be formatted in accordance with one or more digital video codec standards such as H.264, MPEG-4 Part 10 Advanced Video Coding (AVC) or other digital formats such as a Moving Picture Experts Group (MPEG) format (such as MPEG1, MPEG2 or MPEG4), Quicktime format, Real Media format, Windows Media Video (WMV) or Audio Video Interleave (AVI), or another digital video formats, either standard or proprietary that may or may not include a related audio signal. In addition, the frame rate and/or resolution, can be converted when converting the each of the video signals 110 into one or more processed video signals 112, 112′, etc. Further details of the operation of video encoding system 102 including several optional functions and features will be described in greater detail in conjunction with the figures that follow.

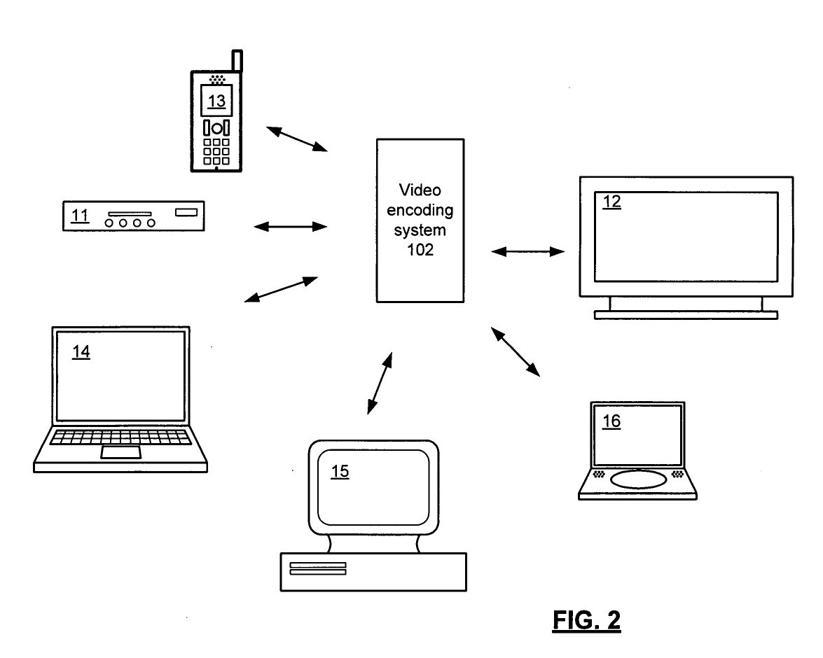

FIG. 2 presents a pictorial representation of example host devices 11-16 in accordance with an embodiment of the present invention. In particular, examples of host device 104 include digital video recorder/set top box 11, television or monitor 12, wireless telephony device 13, computers 14 and 15, personal video player 16, or other host devices that process video signals such as processed video signals 112, 112′, etc. Video encoding system 102 is coupleable to one or more of these host devices via a host interface. Video encoding system 102 can take on any one of a number of form factors such as a PC card, memory card, personal computer memory card international association (PCMCIA) card, universal serial bus (USB) dongle, or other device that is coupleable to one or more host devices via an Ethernet connection, a memory card interface, USB connection, Firewire (IEEE 1394) connection, PCI connection, PCI express connection, small computer system interface (SCSI), PCMCIA interface, or other interface either standard or proprietary. In the alternative, video encoding system 102 can be incorporated directly into the host device.

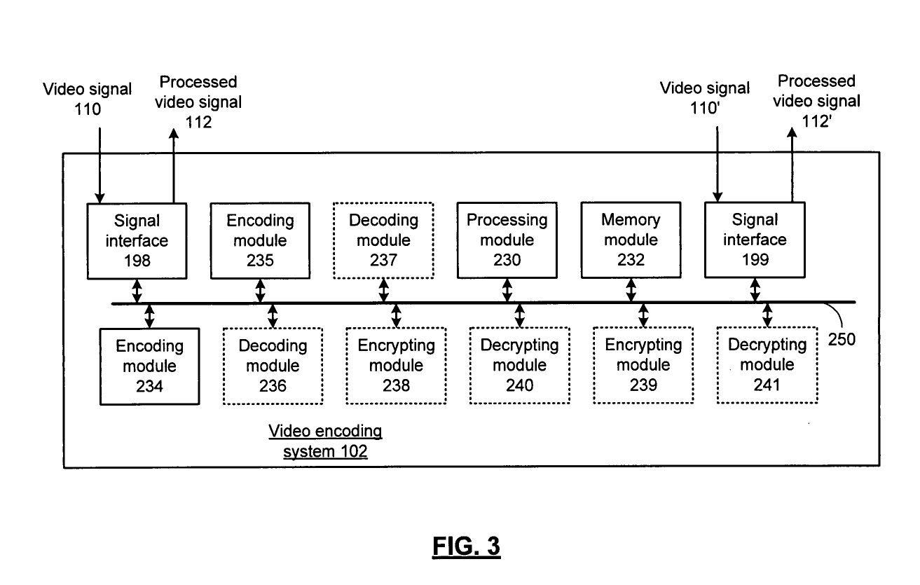

FIG. 3 presents a block diagram representation of a video encoding system 102 in accordance with an embodiment of the present invention. In particular, video encoding system 102 operates in accordance with many of the functions and features of the H.264 standard, the MPEG-4 standard, VC-1 (SMPTE standard 421M) or other standard, to produce processed video signals 112, and 112′ by encoding, transrating, transcaling, and/or transcoding video input signals 110 and 110′ that are received via signal interfaces 198 and 199. In particular, video encoding system 102 operates to optionally decrypt, and then encode, transcode, transrate, transcale the video signal 110 and then optionally encrypt or re-encrypt (“transcrypt”) the video signal 110 to produce a processed video signal 112 that is transcrypted and optionally transcoded, transcaled, transrated, into an altered format and is transferred to a host device via signal interface 198 in conjunction with an optional host protocol. Further, video encoding system 102 operates to optionally decrypt, and then encode, transcode, transrate, transcale the video signal 110′ and then optionally encrypt or transcrypt the video signal 110′ to produce a processed video signal 112′ that is transcrypted and optionally transcoded, transcaled, transrated, into an altered format and is transferred to a host device via signal interface 199 in conjunction with an optional host protocol.

The video encoding system 102 includes a signal interface 198, processing module 230, memory module 232, encoding modules 234 and 235, decoding modules 236 and 237, optional encrypting modules 238 and 239 and optional decrypting modules 240 and 241. The processing module 230, signal interfaces 198 and 199, encoding modules 234 and 235, decoding modules 236 and 237, encrypting modules 238 and 239 and decrypting modules 240 and 241 can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory module 232. Memory module 232 may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

Processing module 230, and memory module 232 are coupled, via bus 250, to the signal interface 198 and a plurality of other modules. The modules of video encoder 102 can be implemented in software, firmware or hardware, depending on the particular implementation of processing module 230. It should also be noted that the software implementations of the present invention can be stored on a tangible storage medium such as a magnetic or optical disk, read-only memory or random access memory and also be produced as an article of manufacture. While a particular bus architecture is shown, alternative architectures using direct connectivity between one or more modules and/or additional buses can likewise be implemented in accordance with the present invention.

In one mode of operation, encoding module 234 produces an encoded or transcoded video stream based on either video signal 110 or based on a decoded and/or decrypted version of video signal 110 as processed by decoding module 236 and/or decrypting module 240. The video signal 110 can be an analog video signal that is optionally encoded, including optional transcaling to a different resolution, transrating to a different frame rate and/or encrypted by video encoding system 102. In the alternative, the video signal 110 can be a digital video signal that is optionally transcoded, including transcaling to a different resolution, transrating to a different frame rate and/or encrypted via a digital encryption standard (DES) algorithm, triple DES algorithm, AES algorithm, Multi2 encryption, Rivest-Shamir-Adeleman (RSA) encryption algorithm, Diffie-Hellman encryption algorithm, or other encryption technique, either public key or otherwise or transcrypted (if the video signal 110 was also encrypted) by video encoding system 102.

In addition, encoding module 235 produces an encoded or transcoded video stream based on either video signal 110′ or based on a decoded and/or decrypted version of video signal 110′ as processed by decoding module 237 and/or decrypting module 241. The video signal 110′ can be an analog video signal that is optionally encoded, including optional transcaling to a different resolution, transrating to a different frame rate and/or encrypted by video encoding system 102. In the alternative, the video signal 110′ can be a digital video signal that is optionally transcoded, including transcaling to a different resolution, transrating to a different frame rate and/or encrypted via a Rivest-Shamir-Adeleman (RSA) encryption algorithm, Diffie-Hellman encryption algorithm, or other encryption technique, either public key or otherwise or transcrypted (if the video signal 110′ was also encrypted) by video encoding system 102. It should be noted that video signals 110 and 110′ can be in the same format or different formats, and the processed video signals 112 and 112′ can also be in the same format or different formats.

Encoding modules 234 and 235 can selectably operate different compression methods and can further include decimation and interpolation to increase or decrease the frame rate and/or resolution of the processed video signal 112, 112′ from the corresponding video signal 110, 110′. While the video content of processed video signal 112 is based on the video content of video signal 110, processed video signal 112 can have a different video format, including a different scale, frame rate, compression or different compression format, and/or can be encrypted or re-encrypted. Similarly, while the video content of processed video signal 112′ is based on the video content of video signal 110′, processed video signal 112′ can have a different video format, including a different scale, frame rate, compression or different compression format, and/or can be encrypted or re-encrypted.

For instance, signal interface 198 receives video signal 110 in a first format and signal interface receives video signal 110′ in a second format. Encoding module 234 generates processed video signal 112 in a third format, based on the video signal 110 and encoding module 235 generates processed video signal 112′ in a fourth format based on video signal 110′. As discussed above, the processed signal 112 is generated contemporaneously with the processed video signal 112′ so that, for instance, video encoding system 102 can simultaneously produce processing video signals 112 and 112′. As further discussed above, the first format can differ from the third format and the second format can differ from the fourth format in terms of compression standard, frame rate, resolution, and/or encryption.

When the first format is itself a digital video format, decoding module 236 can decode video signal 110 from the first format to generate a first decoded video signal. In these circumstances, the encoding module 234 generates the processed video signal 112 by encoding the first decoded video signal, and the third format is at least one, transcoded, transcaled, and transrated, from the first format.

When the second format is itself a digital video format, decoding module 237 decodes the video signal 110′ from the second format to generate a second decoded video signal. In these circumstances, the encoding module 235 generates the processed video signal 112′ by encoding the second decoded video signal, and the fourth format is transcoded, transcaled, and/or transrated, from the second format.

As discussed above, the video signals 110 and/or 110′ can be encrypted signals. Decryption module 240 can decrypt the video signal 110 from the first format to generate a first decrypted video signal. In this case, encoding module 234 generates processed video signal 112 by encoding the decrypted video signal. Similarly, decryption module 241 can decrypt the video signal 110′ to generate a second decrypted video signal. In this case, encoding module 235 generates processed video signal 112′ by encoding the decrypted video signal.

Further, the processed video signals 112 and 112′ can be encrypted by video coding system 102. In particular, encryption module 238 can encrypt the processed video signal from encoder module 234 to form processed video signal 112 (or re-encrypt the processed video signal from encoder module 234 to form processed video signal 112 if the video signal 110 was originally encrypted). Similarly, encryption module 239 can encrypt the processed video signal from encoder module 235 to form processed video signal 112′ (or re-encrypt the processed video signal from encoder module 235 to form processed video signal 112′ if the video signal 110′ was originally encrypted).

While the foregoing description has been based on producing two processed video signals 112 and 112′ based on video signals 110, and 110′, respectively, multiple processed video signals 112, 112′ can be generated based on a single video signal 110 or 110′. For instance, signal interface 198 can receive a video signal 110 in a first format. Encoding module 234 generates processed video signal 112 in a second format based on the content of video signal 110. Encoding module 235 generates processed video signal 112′ in a third format, also based on the content of video signal 110, contemporaneously with the generation of the processed video signal 112. As before, the first format can differ from the second format and the third format. Further, the second format can be transcoded, transcaled, and/or transrated, from the first format and the third format can be transcoded, transcaled, and/or transrated, from the first format. The first, second and third formats are selectable based on the selection data.

When the first format is itself a digital video format, decoding module 236 decodes the video signal 110 from the first format to generate a first decoded video signal and encoding module 234 generates the processed video signal 112 by encoding the first decoded video signal. In addition, if the video signal 110 was originally encrypted, decryption module 240 decrypts the video signal 110 from the first format to generate a decrypted video signal and the encoding module 234 generates the processed video signal 112 by encoding the decrypted video signal.

As discussed above, the processed video signals 112 and/or 112′ can be encrypted or re-encrypted. If so, encryption module 238 encrypts the processed video signal 112 and encryption module 239 encrypts the processed video signal 112′.

As discussed above, video encoding system 102 implements a universal transcoder that is capable of transcoding, transrating, transcrypting and/or transcaling a single video signal 110 contemporaneously into multiple processed video signals 112 and 112′ in different formats and is capable of transcoding, transrating, transcrypting and/or transcaling a multiple video signals 110 and 110′ contemporaneously into multiple processed video signals 112 and 112′ in different formats. In an embodiment of the present invention, the processing module 230 responds to selection data stored in a register of processing module 230 or other memory, such as memory module 232, that selects the particular input format of video signals 110 and optionally 110′ and the desired output format of processed video signals 112 and 112′ including the frame rate, resolution, compression format, whether or not the video signals 110 and/or 110′ are encrypted, whether or not processed video signals 112 and/or 112′ are to be encrypted and the encryption keys or other encryption methods and the other necessary parameters to select the formats of video signals 110 and 110′ and processed video signals 112 and 112′. This selection data can be preloaded in video encoding system 102 based on a particular implementation or application or be stored after selection of the particular formats by a user. While video encoding system has been described in terms of a two-input/two-output system, additional modules could likewise be included to create additional inputs and additional outputs to accommodate additional signals.

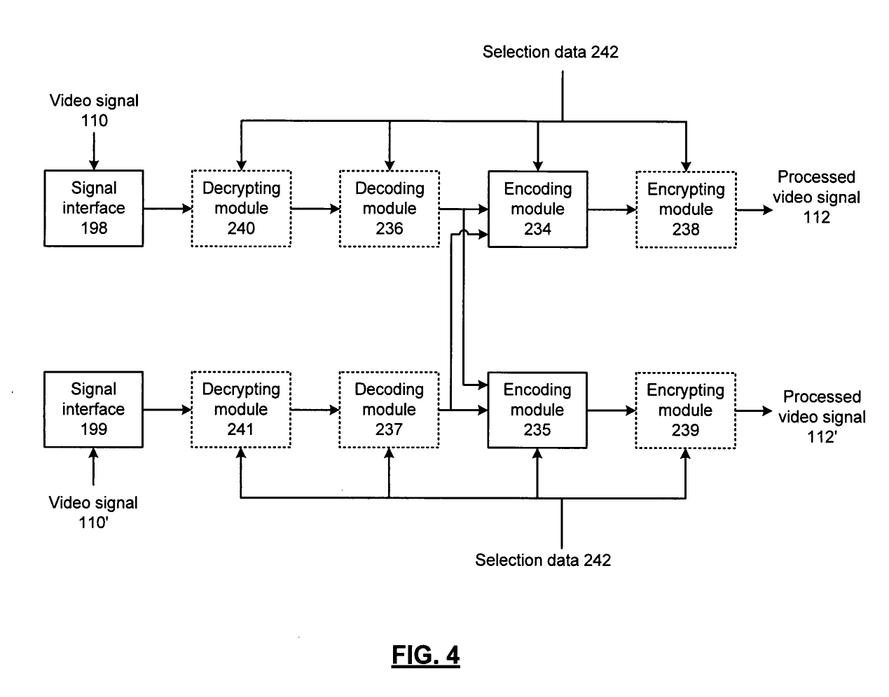

FIG. 4 presents a block diagram representation that represents the processing flow of video encoding system 102 in accordance with an embodiment of the present invention. In particular, this diagram represents a particular processing flow from video signals 110 and 110′ to processed video signals 112 and 112′. Selection data 242 are used to selectively activate or bypass decryption modules 240 and 241 depending on whether video signals 110 or 110′ are encrypted. Further, selection data 242 are used to selectively activate or bypass decoding modules 236 and 237 depending on whether video signals 110 or 110′ are encoded video signals. In addition, selection data 242 are used to selectively activate or bypass encryption modules 238 and 239 depending on whether processed video signals 112 or 112′ are to be encrypted. Further encoding modules 234 and 235 are responsive to selection data 242 to determine whether to encode the content of video signal 110 or the content of video signal 110′.

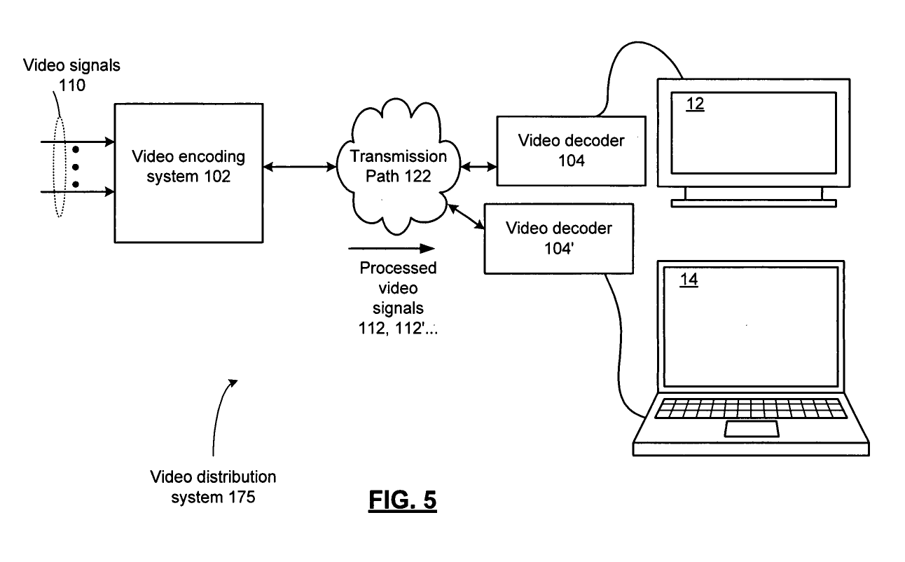

FIG. 5 presents a block diagram representation of a video distribution system 175 in accordance with an embodiment of the present invention. In particular, processed video signals 112 and 112′ are transmitted via a transmission path 122 to a video decoders 104 and 104′. Video decoders 104 and 104′ operate to decode and optionally decrypt the processed video signals 112 and 112′ for display on display devices such as television 12, computer 14 or other display device.

The transmission path 122 can include a wireless path that operates in accordance with a wireless local area network protocol such as an 802.11 protocol, a WIMAX protocol, a Bluetooth protocol, etc. Further, the transmission path can include a wired path that operates in accordance with a wired protocol such as a USB protocol, high-definition multimedia interface (HDMI) protocol, an Ethernet protocol, a powerline networking protocol or other high speed protocol.

The transmission path can be bidirectional and include input selections, and format selections used to populate selection data 242. In this fashion, a user can optionally select the format of processed video signals 112 and 112′ based on the properties of the particular display devices 12, 14, etc and optionally select from different input signals or signal sources in potentially different formats, that correspond to the video signals 110 and 110′.

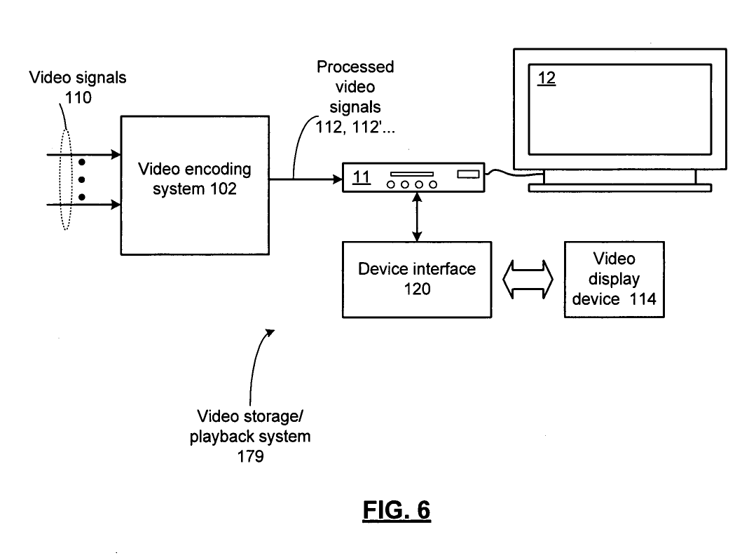

FIG. 6 presents a block diagram representation of a video storage system 179 in accordance with an embodiment of the present invention. In particular, device 11 is a set top box that includes built-in digital video recorder functionality, a stand alone digital video recorder, a DVD recorder/player or other device that decrypts and stores the processed video signal 112 for display on video display device such as television 12. While video encoder 102 is shown as a separate device, it can further be incorporated into device 11. While these particular devices are illustrated, video storage system 179 can include a hard drive, flash memory device, computer, DVD burner, or any other device that is capable of generating, storing, decoding and/or displaying the content of processed video stream 112. In addition, device 11 includes a device interface 120 for coupling to another video device, such as video display device 114 and device 11 can further transfer a compressed video file that includes video signal 112′, to video display device 114 when coupled to device interface 120. Video display devices 114 can include a television, monitor, computer, handheld device or other video display device that creates an optical image stream either directly or indirectly, such as by projection, based on processed video signal 112′, the decoding of a digital video signal or the playback of a stored digital video file.

In operation, video encoding system 102 contemporaneously creates processed video signals 112 and 112′ in two different formats from a single video signal 110 to accommodate playback by two different video display devices such as a television and an personal video recorder. These processed video signals 112 and 112′ can be streamed to video display devices 12 and 114 for simultaneous playback. In the alternative one or both of the processed video signals 112 and 112′ can be stored as a compressed video file for later playback on television 12 or transfer to video display device 114.

In an embodiment of the present invention, device interface 120 includes a wired link that allows the video processing device 114 to be coupled to the device 11 to transfer one or more stored digital video files for playback by the video processing device 114. The coupling can include a Universal Serial Bus (USB) connection, an Institute of Electrical and Electronics Engineers (IEEE) 1394 (Firewire) connection, or other wired connection that operates in accordance with either a standard or custom interface protocol. In this fashion, a video display device 114, such as an MP3/video player, game/video player PDA/video player, cellphone/video player or other handheld device can be coupled to the device 11 to transfer compressed digital audio and/or video files between the two devices through a synchronization or “sync” operation, or by command from one or the other of the two devices. In addition, the device 11 can optionally supply power to the video display device 114 when coupled, in order to operate or recharge the device.

In another embodiment of the present invention, the device interface 120 includes a wireless link between the device 11 and the video display device 114 that operates in accordance with a wireless network protocol such as 802.11a,b,g,n (referred to generically as 802.11x), Bluetooth, Ultra Wideband (UWB) or other wireless connection that operates in accordance with either a standard or custom interface protocol.

In a further embodiment, the device interface 120 couples to video display device 114 using a removable memory, such as a removable drive, disk or memory card that is couplable to either the device interface 120 or the video display device 114. In this fashion, the removable memory can be written with a compressed digital video file when inserted in the device interface 120 and read when inserted in video display device 114 for playback of the associated content.

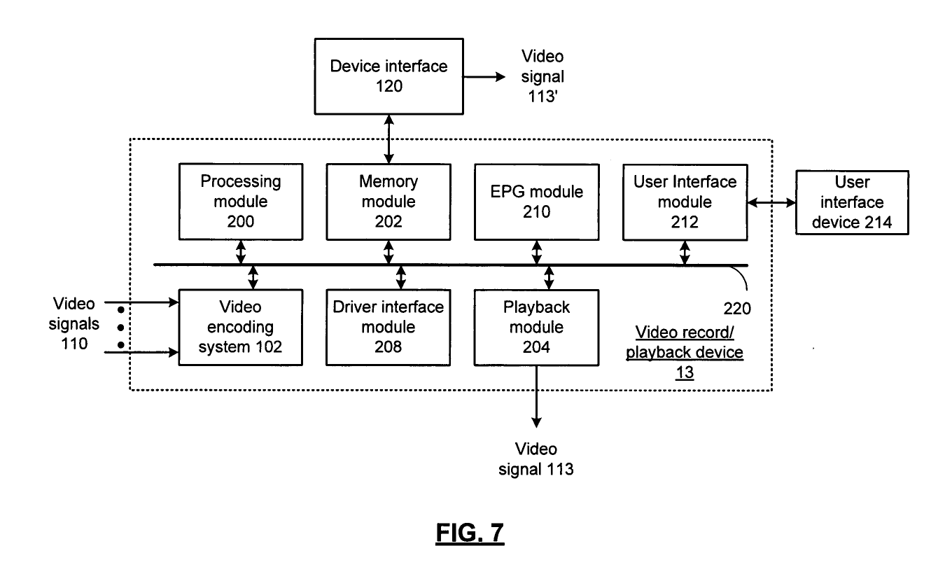

FIG. 7 presents a block diagram representation of a video record/playback device 13 in accordance with an embodiment of the present invention. In particular, video record/playback device 13, such as device 11, that receives one or more video signals 110 and via video encoding system 102 produces processed video signal 112 for storage and/or display on a video display device such as television 12 and further produces processed video signal 112′ for display on video display device 104 as either the playback of a compressed digital video file or a buffered live (realtime or near realtime) video signal 113′ (that includes processed video signal 112′ and optionally other data or information) and that is in a format that corresponds to the format of video display device 104.

The video record/playback includes a processing module 200, and memory module 202 that are coupled to a plurality of other modules, such as Electronic Program Guide (EPG) module 210, user interface module 212, video encoding system 102, driver interface module 208, and playback module 204 via a bus 220. Processing module 200 can be implemented using a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory module 202. Memory module 202 may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

The other modules of video record playback device 13 can be implemented in software, firmware or hardware, depending on the particular implementation of processing module 200. It should also be noted that the software implementations of the present invention can be stored on a tangible storage medium such as a magnetic or optical disk, read-only memory or random access memory and also be produced as an article of manufacture.

In operation, driver interface module 208 stores a plurality of record settings, the plurality of record settings corresponding to the video display devices that may be coupled thereto. In particular, this includes first settings corresponding to the video display device 104, and second settings corresponding to the video display device 114. Video encoding system 102 is coupled to the driver interface module 208 to encode the video signal 110 based on the first settings to produce a processed video signal 112 in a first format, and to contemporaneously encode the video signal 110 based on the second settings to produce a second processed video signal 112′ in a second format. In an embodiment of the present invention, the first format is different from the second format, based on the differences in resolution, compression format, compression depth, etc., between the video display device 104 and video display device 114. The first and second processed video signals can be streamed to support real-time or near real-time display of the video signal 110 by the video display devices 104 and/or 104 with buffering to allow the playback to be paused, rewound, fastforwarded, etc. In the alternative, one or more of the first and second processed video signals can be stored for later playback by playback module 204 or transferred to video display device 114 to enable autonomous playback of the stored video programming.

Memory module 202 is coupled to the video encoding system 102 for storing a plurality of compressed video files including a first compressed video file that is based on the first processed video signal. As discussed above, memory module can include a plurality of different memory devices. In an embodiment of the present invention, the plurality of compressed video files are stored in a large capacity storage medium such as a hard disk drive or flash memory, however other memory devices may likewise be used, and in particular, a removable memory device can be used to store the compressed video files that are formatted for video display device 114 in the embodiment where the device interface 120 is implemented with a removable memory.

EPG module 210 includes an electronic program guide that allows a user, through operation of user interface module 212 and one or more user interface devices 214 to obtain information regarding current or upcoming programs that can be viewed or recorded. Playback module 204 is coupled to memory module 202 to produce the video signal 113 that is based on processed video signal 112 stored in a selected one of the plurality of compressed video files. User interface 212 and user interface device 214 provides a mechanism for a user of video record/playback device 13 to establish playback and record settings and preferences, to interactively choose programs to record, to select stored programs for playback, to pause, fast forward and rewind playback of compressed video files and buffered live video streams used to generate the video signal 113.

In an embodiment of the present invention, the one or more user interface devices 214 include a display, such as a separate liquid crystal, plasma or other display device capable of displaying text and/or graphics. Alternatively, user interface module 212 can generate overlay text, and graphics such as one or more menus to implement a menu driven graphical user interface that is presented as video signal 113′ for display on video display device 104. In addition, user interface device 214 can include a number of buttons, a keyboard, a mouse, an infrared or wireless remote control or other pointing, indication or other user interface device that allows a user to select different choices or preferences, to browse and select from a plurality of menus and/or to otherwise interact with the record/playback device 13 in order to provide the use commands necessary to control the operation of the device.

While device interface 120 has been described in terms of being coupled to a single video display device 114, device interface 120 can likewise include multiple interfaces for coupling to two or more video display devices, with potentially different formats and through potentially different interfaces. For example, device interface can include a memory card slot for accepting a memory card used to couple compressed video files recorded by video record playback device 13 in a format suited to a handheld video display device, such as an LG CE500 video enabled cellphone, while further providing a USB 2.0 port to transfer compressed video files recorded by video record playback device 13 in a potentially different format to a digital audio/video player such as an Apple iPod, etc. Likewise the plurality of record settings can include three or more settings and the driver module can encode the video signal 110 to produce a three or more processed video signals in different formats.

While a particular architecture is described above, other architectures including alternative bus architectures, and architectures where the functionality of bus 220 is replaced by one or more direct connections or links, can likewise be implemented. In a particular embodiment of the present invention, the video record/playback device 13 is implemented using a computer having a TV tuner card, broadband modem or other receiver for selectively receiving video signal 110. Video encoding system 102, driver interface module 208, playback module 204, EPG module 210 and user interface module 212 are implemented by Microsoft Media Center Edition 2005 along with other software add-ons that operate in conjunction with the hardware of the computer to perform the functionality of video record/playback device 13.

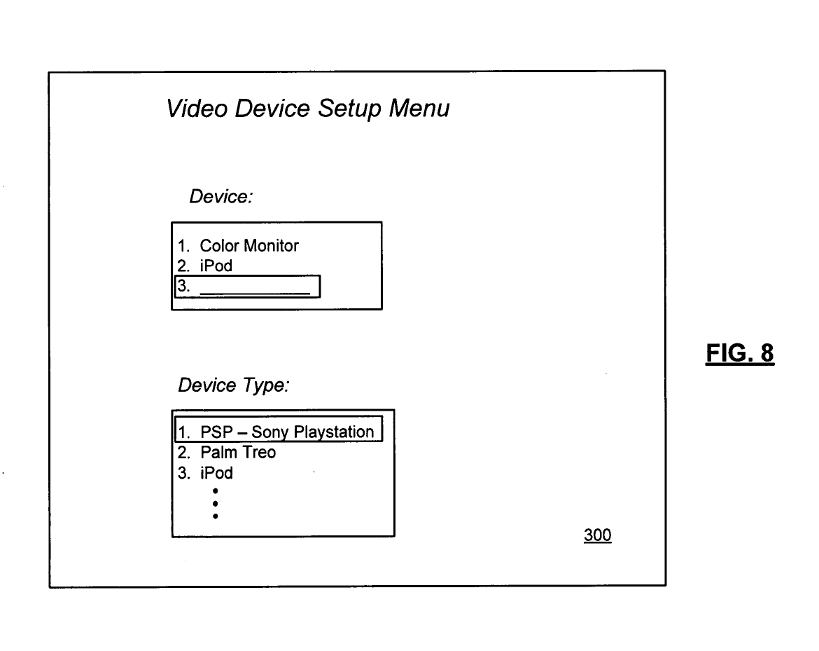

The further operation of video record/playback device 13 will described in addition to further examples and optional features in conjunction with FIGS. 8-10 that follow.

FIG. 8 presents a pictorial representation of a video device setup menu 300 in accordance with an embodiment of the present invention. In this embodiment, user interface module 212 selects the first settings based on a user selection of a first device type, selects the second settings based on a user selection of a second device type, etc. In particular, device setup menu 300 allows a user to establish the first settings, second settings, third settings, based on the characteristics of various devices that have prestored configurations. As shown in FIG. 8, two devices, a Color Monitor and an iPod have already been selected. The settings corresponding to a third device are selected by the user by selecting the particular one of a plurality of known devices from the list of device types. In this case, the user selects his or her third device from the list, in this case, a Sony PlayStation Portable from the list. In response, driver interface module 208 retrieves the particular compression format, screen resolution, etc., that are known to correspond to this particular device so that when a video signal 110 is received, a processed video signal 112 or 112′ can be generated in a format that matches the characteristics of this device (as well as additional processed video signals 112, 112′, etc. in other formats for one or more other devices that have been set up in a similar fashion).

In an alternative embodiment, user interface module 212 can select one or more of the first and second settings, such as screen resolution, compression depth, and a compression format (e.g. digital video format such as a Motion Picture Experts Group (MPEG) format (such as MPEG1, MPEG2 or MPEG4), Quicktime format, Real Media format, Windows Media Video (WMV) or Audio Video Interleave (AVI), h.264 or another digital video format, either standard or proprietary), based on a user's direct selection of these particular settings for each corresponding device. While providing additional work for the user to determine and enter the particular settings for each device, this embodiment allows the flexibility of entering settings information for devices that may be configured differently or otherwise having settings that are optional to a particular device type or are unknown to the video record playback device 13.

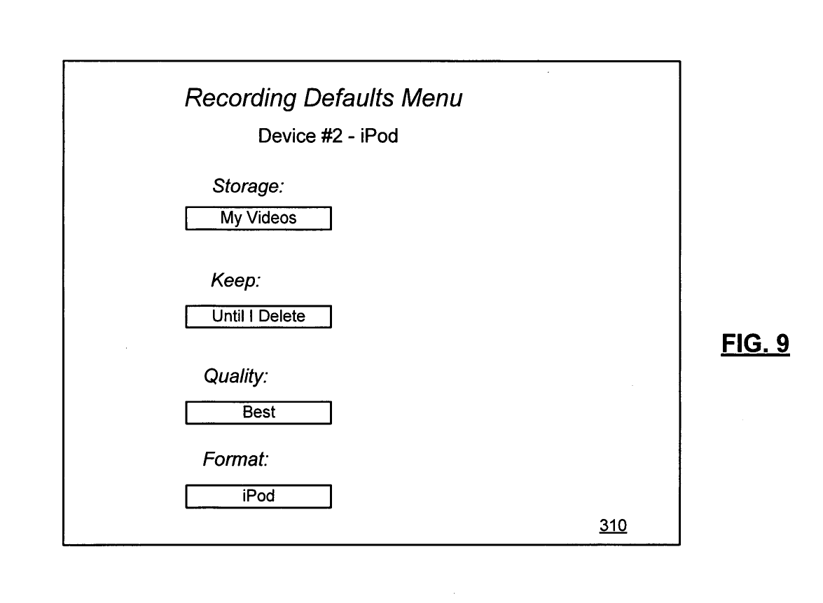

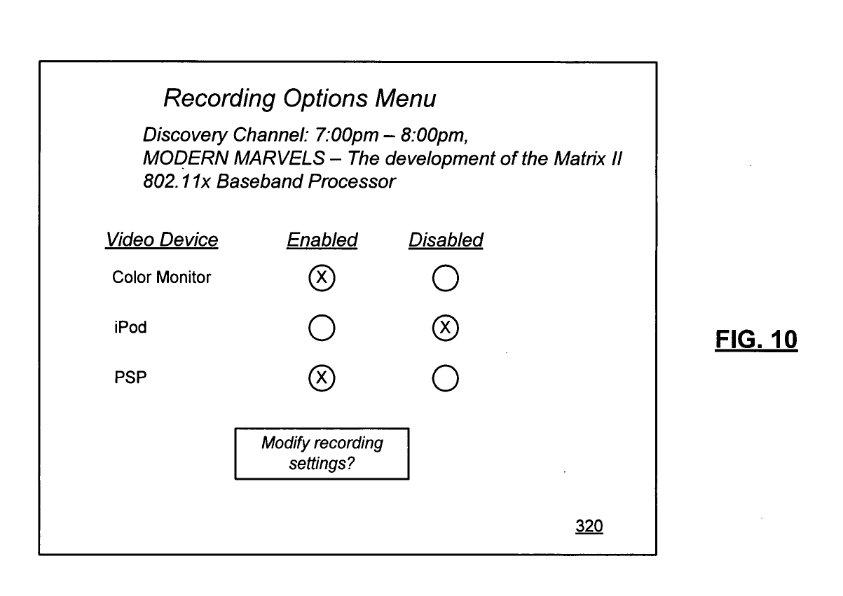

FIG. 9 presents a pictorial representation of a recording defaults menu 310 in accordance with an embodiment of the present invention. In particular a recording defaults menu 310 is presented that allows a user, through user interface device 214 and user interface module 212 to choose other settings for each video display device. In this example, the recording defaults can be set for the user's second device, the Apple iPod. Under the “Storage” section, the user selects the location that compressed video files will be stored, in this case, the “My Videos” folder of a hard disk drive of the video record/playback device 13. In the “Keep” section, the user selects the particular time period that the compressed video file will be kept, for instance, 1-day, 2-days, 5-days, 10 days, or, in this case, until deleted manually by the user. In the quality section, the user manually chooses the amount of compression (compression depth) by selecting one of a plurality of quality ratings, such as Low, Medium, High, or in this case, “Best”. In the “Format” section, the menu displays the format corresponding to the device, in this case the device type of “iPod”. Each video signal recorded is then recorded with these recording defaults, unless manually altered by the user prior to recording in a recording options menu, such as the recording options menu shown in FIG. 10.

FIG. 10 presents a pictorial representation of a recording options menu 320 in accordance with an embodiment of the present invention. In an embodiment, the driver interface module 208 selectively enables or disables a multiple recording signal for each video display device on a device by device basis. In response, the video encoding system 102 encodes the video signal to produce processed video signal 112, 122′, etc. for a particular video display device only when the multiple recording signal for that device is enabled. User interface module 212 selects whether the multiple recording signal is enabled based on a user selection, that optionally indicates a particular program to be recorded and the particular video display devices that are selected In the example shown, the user has selected to record the Discovery Channel from 7:00 pm-8:00 pm, on that day, in order to record a particular episode of the television show, MODERN MARVELS, relating to the development of the Matrix II 802.11x baseband processor. The program will be recorded in a format corresponding to each of the selected video display devices, in this case, the color monitor and the Sony PlayStation Portable. The recording will proceed based on the recording defaults for each device, unless modified by the user by selecting “Modify recording settings” button, and modifying the particular recording settings for one or more of the devices for this particular recording.

In this fashion, the video record/playback device 13 will record this broadcast, creating two compressed video files that are stored. A first compressed video file formatted for playback on the color monitor and the second compressed video file formatted for playback on the Sony PSP. In an embodiment, the second compressed video file can be transferred to the Sony PSP when the device is coupled via the device interface 120. The user then has the option of watching the show via the color monitor of video processing system 125 or via the Sony PSP if the user is on the go.

While the embodiment above describes enabling the multiple recording feature on a device by device basis, in an embodiment of the present invention, the driver interface module 208 selectively enables or disables a multiple recording signal that applies only to the secondary devices (second and third devices—such as the iPod and Sony PSP in the examples above) that are coupled via the device interface 120. In response, the video encoding system 102 encodes the video signal to produce processed video signal for the second and third devices only when the multiple recording signal is enabled. As discussed above, the multiple recording signal can be selectively enabled or disabled for each particular program to be recorded.

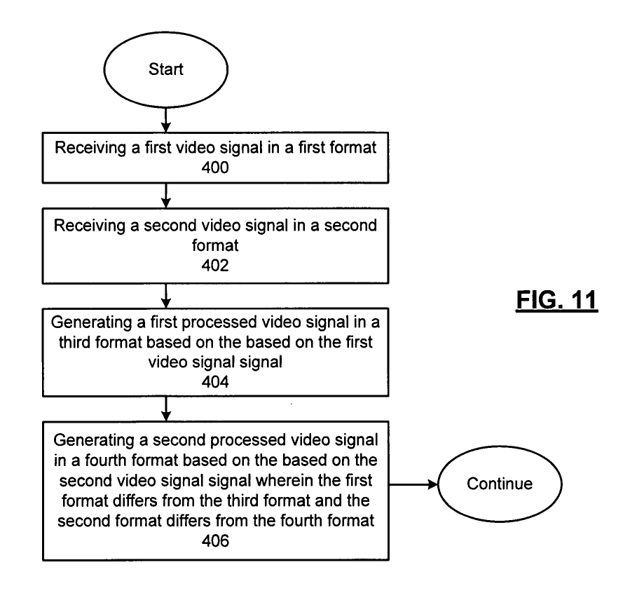

FIG. 11 presents a flowchart representation of a method in accordance with an embodiment of the present invention. In particular a method is presented for use in conjunction with one or more functions and features described in conjunction with FIGS. 1-10. In step 400, a first video signal is received in a first format. In step 402, a second video signal is received in a second format. In step 404, a first processed video signal is generated in a third format based on the first video signal. In step 406, a second processed video signal is generated in a fourth format based on the second video signal, wherein the second processed signal is generated contemporaneously with the first processed video signal and wherein the first format differs from the third format and the second format differs from the fourth format. The third format can be transcoded, transrated, transcaled and/or transcrypted from the first format and the fourth format format can be transcoded, transrated, transcaled and/or transcrypted from the second format.

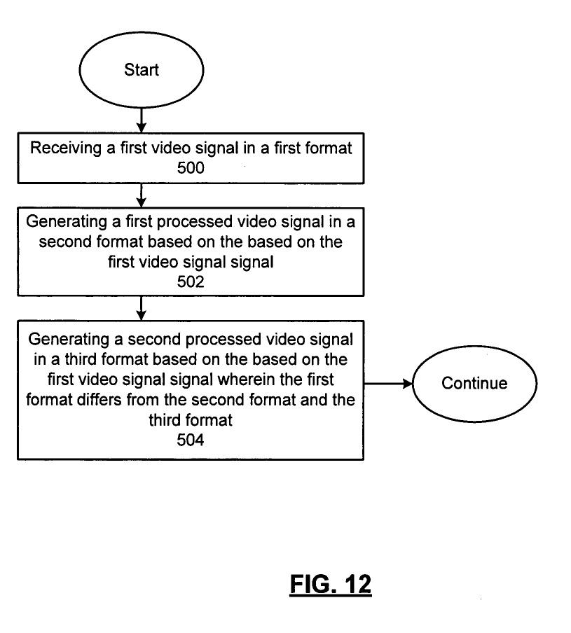

FIG. 12 presents a flowchart representation of a method in accordance with an embodiment of the present invention. In particular a method is presented for use in conjunction with one or more functions and features described in conjunction with FIGS. 1-11. In step 500, a first video signal is received in a first format. In step 502, a first processed video signal is generated in a second format from the first video signal. In step 504, a second processed video signal is generated in a third format based on the first video signal, wherein the second processed signal is generated contemporaneously with the first processed video signal, and wherein the first format differs from the second format and the third format. The second format can be transcoded, transrated, transcaled and/or transcrypted from the first format and the second format can be transcoded, transrated, transcaled and/or transcrypted from the first format.

As used herein, the term video signal includes video signals, with or without accompanying audio signals.

While particular combinations of various functions and features of the present invention have been expressly described herein, other combinations of these features and functions are possible that are not limited by the particular examples disclosed herein are expressly incorporated in within the scope of the present invention.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As the term module is used in the description of the various embodiments of the present invention, a module includes a functional block that is implemented in hardware, software, and/or firmware that performs one or more functions such as the processing of an input signal to produce an output signal. As used herein, a module may contain submodules that themselves are modules.

Thus, there has been described herein an apparatus and method, as well as several embodiments including a preferred embodiment, for implementing a video encoding system, video processing and video storage systems for use therewith and with other processing systems. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. An encoding system comprising:
a first signal interface for receiving a first video signal in a first format;
a second signal interface for receiving a second video signal in a second format;
a first encoding module, coupled to the first signal interface, that generates a first processed video signal in a third format based on the first video signal; and
a second encoding module, coupled to the second signal interface, that generates a second processed video signal in a fourth format based on the second video signal, wherein the second processed signal is generated contemporaneously with the first processed video signal;
wherein the first format differs from the third format and the second format differs from the fourth format.

2. The encoding system of claim 1 further comprising:
a first decoding module, coupled to the first signal interface and the first encoding module, that decodes the first video signal from the first format to generate a first decoded video signal;
wherein the first encoding module generates the first processed video signal by encoding the first decoded video signal, and wherein the third format is at least one of, transcoded, transcaled, and transrated, from the first format.

3. The encoding system of claim 2 further comprising:
a second decoding module, coupled to the second signal interface and the second encoding module, that decodes the second video signal from the second format to generate a second decoded video signal;
wherein the second encoding module generates the second processed video signal by encoding the second decoded video signal, and wherein the fourth format is at least one of, transcoded, transcaled, and transrated, from the second format.

4. The encoding system of claim 1 further comprising:
a first decryption module, coupled to the first signal interface and the first encoding module, that decrypts the first video signal from the first format to generate a first decrypted video signal;
wherein the first encoding module generates the first processed video signal by encoding the first decrypted video signal.

5. The encoding system of claim 4 further comprising:
a second decryption module, coupled to the second signal interface and the second encoding module, that decrypts the second video signal from the second format to generate a second decrypted video signal;
wherein the second encoding module generates the second processed video signal by encoding the second decrypted video signal.

6. The encoding system of claim 1 further comprising:
a first encryption module, coupled to the first encoding module, that encrypts the first processed video signal.

7. The encoding system of claim 6 further comprising:
a second encryption module, coupled to the second encoding module, that encrypts the second processed video signal.

8. The encoding system of claim 1 wherein at least one of, the second format and the fourth format is a selectable format based on selection data.

9. The encoding system of claim 1 wherein at least one of, the first format and the third format is a selectable format based on selection data.

10. An encoding system comprising:
a first signal interface for receiving a first video signal in a first format;
a first encoding module, coupled to the first signal interface, that generates a first processed video signal in a second format based on the first video signal; and
a second encoding module, coupled to the first signal interface, that generates a second processed video signal in a third format based on the first video signal, wherein the second processed signal is generated contemporaneously with the first processed video signal;
wherein the first format differs from the second format and the third format.

11. The encoding system of claim 10 further comprising:
a first decoding module, coupled to the first signal interface, the first encoding module and the second encoding module, that decodes the first video signal from the first format to generate a first decoded video signal;
wherein the first encoding module generates the first processed video signal by encoding the first decoded video signal, and wherein the second format is at least one, transcoded, transcaled, and transrated, from the first format and the third format is at least one of, transcoded, transcaled, and transrated, from the first format.

12. The encoding system of claim 10 further comprising:
a first decryption module, coupled to the first signal interface and the first encoding module, that decrypts the first video signal from the first format to generate a first decrypted video signal;
wherein the first encoding module generates the first processed video signal by encoding the first decrypted video signal.

13. The encoding system of claim 10 further comprising:
a first encryption module, coupled to the first encoding module, that encrypts the first processed video signal.

14. The encoding system of claim 13 further comprising:
a second encryption module, coupled to the second encoding module, that encrypts the second processed video signal.

15. The encoding system of claim 10 wherein at least one of, the second format and the third format is a selectable format based on selection data.

16. The encoding system of claim 10 wherein the first format is a selectable format based on selection data.

17. A method comprising:
receiving a first video signal in a first format;
receiving a second video signal in a second format;
generating a first processed video signal in a third format based on the first video signal; and
generating a second processed video signal in a fourth format based on the second video signal, wherein the second processed signal is generated contemporaneously with the first processed video signal;
wherein the first format differs from the third format and the second format differs from the fourth format.

18. The method of claim 17 wherein the third format is at least one of, transcoded, transrated, transcaled and transcrypted from the first format and the fourth format is at least one of, transcoded, transrated, transcaled and transcrypted from the second format.

19. A method comprising:
receiving a first video signal in a first format;
generating a first processed video signal in a second format from the first video signal; and
generating a second processed video signal in a third format based on the first video signal, wherein the second processed signal is generated contemporaneously with the first processed video signal;
wherein the first format differs from the second format and the third format.

20. The method of claim 19 wherein the second format is at least one of, transcoded, transrated, transcaled and transcrypted from the first format and the second format is at least one of, transcoded, transrated, transcaled and transcrypted from the first format.
